(19) United States
(12) Patent Application Publication
(10) Pub. No.: US 2016/0123468 A1
(43) Pub. Date: May 5, 2016

(54) SEAL FOR AN OIL SEALED BEARING ASSEMBLY

(71) Applicant: Cathedral Energy Services Ltd., Nisku (CA)

(72) Inventors: Dean FOOTE, Edmonton (CA); Jason WILLIAMS, Nisku (CA)

(21) Appl. No.: 14/538,873

(22) Filed: Nov. 12, 2014

(30) Foreign Application Priority Data
Oct. 30, 2014 (CA) 2 869 885

(51) Int. Cl. F16J 15/16

(52) U.S. Cl. CPC F16J 15/166

(57) ABSTRACT

There is provided a seal assembly for sealing against an outer surface of a rotating shaft. The seal assembly has a seal housing with an inner surface defining a central bore sized to receive the shaft and a seal-receiving groove formed in the inner surface and open to the central bore. An elastomeric seal having first and second side surfaces and an inner seal surface extending between the first and second side surfaces is positioned within the seal-receiving groove, and the inner seal surface sealingly engages the rotating shaft in operation. The seal assembly has an anti-extrusion ring formed from a pliable material and being a split ring positioned within the seal groove adjacent to the first side surface of the elastomeric seal, such that the inner diameter of the anti-extrusion ring conforms to the outer diameter of the shaft in response to pressure applied by the elastomeric seal.

### TECHNICAL FIELD

This relates to a seal and a method of preventing seal extrusion of seals in an oil sealed bearing assembly of a down hole drilling motor.

### BACKGROUND

Referring to FIG. 1, an example of a down-hole drilling motor, generally indicated by reference numeral 100, has a bearing assembly (not shown), a bent housing 102, which may also be an adjustable housing, and a power section 104. The total length of drilling motor 100 may range from approximately 5 m to 10m depending upon size and configuration of the power section 104. The bent housing 102 provides a bend 106 in the assembly approximately 1-2 m from the bottom where the drill bit 108 is attached. The bend 106 can typically range from 0-4 degrees.

Referring to FIG. 1A, in most cases, the drilling motor 100 is forced to straighten to fit into the well bore 112. This is due to a combination of the bit 108, the bent housing 102 and the extreme length of the power section 104. The bit 108 remains central in the well bore 112, while the backside of the bend is in contact with the sidewall of the well bore 112 at a contact point 114, and the power section 104 is forced to bend or flex to fit into the confines of the well bore 112. This straightening action subjects the bearing assembly to significant radial loads due to its position between the bit 108 and the bend 106 of the motor 100.

When the drilling motor 100 is inserted into the well bore 112, the radial loading deflects the bearing mandrel of the bearing assembly to the side. The deflected mandrel is resisted by radial bearings in the bearing assembly, but it is difficult to hold the bearing mandrel perfectly rigid and eliminate the deflection. In addition, the side loading and deflection will vary due to hole conditions and drilling operations. As a result, the deflection causes the gap between the seal lands in the housing that contains the seals, and the bearing mandrel to change, with one side decreasing and the opposite side increasing. To accommodate this deflection, additional clearance must be provided between the seal lands and the rotating bearing mandrel. If the additional clearance is not provided, the seal lands could contact bearing mandrel and result in severe heat generation while the bearing mandrel rotates relative to the seals and seal lands. The severe heat generation causes damage to both parts in contact and can damage the elastomer seals. Often the result is failed seals and failed drilling motor due to drilling fluid invasion of the bearing assembly.

A requirement of an elastomer seal to be effective under pressure is to maintain the gap between the seal lands and a shaft to a very small clearance. Typically, a gap of about 0.001″ to 0.009″ is used fir a variety of seal types and sizes. When the gap size exceeds the recommended clearance, pressure can force a portion of elastomer seal to protrude into the enlarged gap and damage the seal.

These typical clearances For elastomer seals are insufficient for use in most drilling motors. Due to the side loading, drilling motors require much larger clearances for the seals, such as in the range of 0.025″ or more, to prevent contact between seal lands and the rotating bearing mandrel. As a consequence, elastomer seals are damaged and fail from protrusion into these enlarged gaps when pressure is applied across the seals. This thrill of failure is called seal extrusion and is common in drilling motors. As the gap size increases, the pressure causing extrusion failures decreases.

To overcome these problems, there are two popular methods employed. The first is to ensure the seals are not exposed to substantial differential pressures through the use of control mechanisms such as flow restrictors. These devices may he placed above or below the oil sealed chamber of the drilling motor. They provide a means to limit the differential pressures across the seals to approximately 300 pounds per square inch, (psi) or less, when the drilling fluid pressure could be in excess of 1000 psi. The reduced pressure differential on the bottom seals allows for larger extrusion gaps to accommodate bearing mandrel deflections.

Generally, a flow restrictor consists of concentric inner and outer rings, with a controlled clearance between them. The outer ring is stationary and the inner ring rotates with the bearing mandrel. A portion of the drilling fluid is allowed to leak through the two rings and vent to the outside of the drilling motor. They are generally 4 to 6 inches long and must be capable of resisting wear from the abrasive drilling fluid. They are typically made of sintered tungsten carbide or a composite of tungsten carbide attached to steel.

The disadvantages of the flow restrictor method include the expense of the flow restrictor rings and the length they add to the bearing assembly.

Referring to FIG. 2, there is shown a drilling motor 100 with a flow restrictor 120 on top of an oil sealed bearing assembly 122. Directly below the flow restrictor 120, and directly above the balance piston 124 are ports 126 in the outer housing 127 to vent the drilling fluid that passes through the flow restrictor 120. Locating the flow restrictor 120 on top of the bearing assembly 122 ensures that the bottom seals 128 are balanced and are not subjected to the higher pressure inside the drill string. With this arrangement, a larger gap is possible between the rotating bearing mandrel 130 and the stationary seal lands 132 that contain the seals 134 because there is no significant pressure to extrude the seals 134 into the enlarged gap 138. As a result, the possibility of seal extrusion is reduced.

Referring to FIG. 2A, there is shown a drilling motor 100 with a flow restrictor 120 at the bottom of the oil sealed bearing assembly 122. Directly below the bottom seals 128 of the bearing assembly 122 and directly above the flow restrictor 120 are ports 140 in the bearing mandrel 130 to vent high pressure drill string fluid from inside the bearing mandrel 130 to pass through the flow restrictor 120. With the flow restrictor 120 on the bottom of the hearing assembly 122, the sealed oil chamber 142 is maintained at the higher drill string pressure and the pressure differential across the bottom seals 128 is relatively small. With this arrangement, a larger gap 138 is possible between the rotating bearing mandrel 130 and the stationary seal lands 132 that contain the seals 128 because there is no significant pressure to extrude the seals into the enlarged gap 138. As a result, the possibility of seal extrusion is reduced. In each of FIGS. 2 and 2A, the flow restrictor 120 increases the length of the bearing assembly 122 relative to a drilling motor without a flow restrictor, such as shown in FIGS. 2B and 2C.

Referring to FIG. 2B, there is shown a drilling motor 100 with a seal housing 144 to house the bottom seals 128. The carrier 144 is allowed to “float” with the bearing mandrel 130 as it deflects, but is not permitted to rotate with the bearing mandrel 130. Special features are generally included that keep the carrier 144 from rotating, but they tend not to be robust enough to stand up to the extreme environment and rugged use. Failures often occur due to the failure of the carrier 144 rather than the seals 128.

Referring to FIG. 2C, there is shown is a drilling motor 100 without a flow restrictor above or below the oil sealed bearing assembly 122. The advantages are a shorter bearing assembly and reduced costs due to the elimination of the flow restrictor. In addition, eliminating the seal housing 144 and placing the seals 128 directly in the housing 150 increases the strength, simplicity and cost of the bearing assembly 122.

Referring to FIGS. 3, 3A and 3B, the second method, which places the seals directly in the housing 150, must have additional clearance 156 between the housing lands and the bearing mandrel 150 to accommodate bearing mandrel deflection.

FIGS. 4-4B depicts the process by which seal failure may occur as a result of seal extrusion. FIG. 4 shows pressure being applied to a seal 152 and FIG. 4A shows how the seal 152 reacts to a small pressure application from the oil. As can be seen, the seal 152 is pushed to the low-pressure side of the seal groove 154 and takes the shape of the space available. Referring to FIG. 4B, the seal 152 has been extruded into the enlarged gap 156. The portion of the seal 152 that is extruded into the gap 156 will he damaged and “nibbled” off. Repeated applications of pressures will cause the seal 152 to fail and allow drilling fluid into the bearing assembly. The drilling fluid causes severe damage to the bearing assembly and ultimately fails. The same principle is depicted in FIG. 5-5B, but with an opposite pressure. FIGS. 6 and 6A depicts the “nibbling” of the extruded portions of the seal. Repeated applications of pressure will cause the “nibbling” to increase until the seal 152 fails.

In some circumstances, back-up rings 160 are also used to try and prevent seal extrusion. Back-up rings 160 are made from an elastomeric material that generally retain their shape under pressure. FIG. 7-7B are examples of back-up rings 160, also referred to anti-extrusion rings, that have previously been used to attempt to reduce seal extrusion, All are designed to prevent seal extrusion, but do not have the ability to prevent extrusion when the bearing mandrel 130 deflects as in the drilling motor application. Conventional anti-extrusion rings 160 are not made for large deflections of a rotating shaft 130, such as would be encountered when shaft 130 is a bearing mandrel in a drilling motor. The radial space between the shaft 130 and gland 154 is often filled with either the anti-extrusion ring 160, or a combination of anti-extrusion ring 160 and elastomer 152. In both cases, deflection causes excessive wear when the shaft 130 deflects and leaves an extrusion gap 156 when deflection is removed. The result is failure due to eventual extrusion. This is shown in FIG. 8-8C. FIG. 8 shows the seal 152 and back-up ring 160 initially installed. The back-up ring 160 is the same cross section as the seal 152, where the height of the back-up ring 160 matches the height from the rotating shaft 130 to the outer extent of the seal groove 154. As the hearing mandrel 130 deflects and reduces the gap 156, the back-up ring 160 is squeezed against the rotating bearing mandrel 130 and wears. When the deflection of the bearing mandrel 130 is removed, the back-up ring 160 can no longer maintain a reduced gap with the surface of shaft 130 because it has been worn away by the shaft 130. The elastomer seal 152, under pressure, will begin to extrude into the gap 156 between the worn back-up ring 160 and the rotating bearing mandrel 130 and contribute to seal failure.

### SUMMARY

According to an aspect, there is provided a seal assembly for sealing against an outer surface of a rotating shaft having an outer diameter, the seal assembly comprising a seal housing having an inner surface defining a central bore that is sized to receive the shaft, the seal housing having a seal-receiving groove formed in the inner surface and that is open to the central bore, an elastomeric seal positioned within the seal-receiving groove, the elastomeric seal having a first side surface and a second side surface, and an inner seal surface that extends between the first and second side surfaces, the inner seal surface scalingly engaging the rotating shaft in operation, and an anti-extrusion ring positioned within the seal groove and adjacent to the first side surface of the elastomeric seal, the anti-extrusion ring having an inner diameter and an outer diameter, the anti-extrusion ring being formed from a pliable material and being a split ring having a first end and a second end such that the inner diameter of the anti-extrusion ring conforms to the outer diameter of the shaft in response to pressure applied by the elastomeric seal.

According to another aspect, the first and second ends of the split ring may be defined by a cut that extends from a first side of the ring to a second side of the ring.

According to another aspect, the first and second ends of the split ring may be defined by an angled cut, the angled cut acting as a ramp to permit the anti-extrusion ring to expand and contract as the first end moves relative co the second end along the angled cut.

According to another aspect, an outer surface of the anti-extrusion ring may comprise a curved surface such that the elastomer forms around the curved surface under pressure.

According to another aspect, an inner surface of the anti-extrusion ring may be fiat such that, as the inner surface engages the shaft, extrusion of the elastomeric seal between the shaft and the anti-extrusion ring under pressure is prevented.

According to another aspect, the first side of the seal assembly may be the high pressure side of the seal assembly.

According to another aspect, the first side of the seal assembly may be the low pressure side of the seal assembly.

According to another aspect, the seal assembly may further comprise a second anti-extrusion ring adjacent to the second side of the elastomeric seal.

### DESCRIPTION OF THE DRAWINGS

These and other features will become more apparent from the following description of the appended drawings. The drawings are for illustration only and are not intended in any way to limit the scope of the invention to the particular embodiment or embodiments shown.

FIG. 1 is a representation of a drilling motor and the interference it experiences when inserted into the well bore.

FIG. 1A is a representation of the drilling motor fit within the confines of the well bore and an indication of the side loading the drilling motor subjected to when forced into the well bore.

FIG. 2 is a drilling motor with a flow restrictor on top of the oil sealed bearing assembly.

FIG. 2A is a drilling motor with a flow restrictor at the bottom of the oil sealed bearing assembly.

FIG. 2B is a drilling motor with a seal housing to house the bottom seals.

FIG. 2C is a drilling motor without a flow restrictor above or below the oil sealed bearing assembly and without a seal housing to house the seals.

FIG. 3-3B show detailed views of a typical seal arrangement with multiple seals and a larger seal gap, 0.025″ minimum, between the rotating bearing mandrel and the stationary housing, which contains the seals.

FIG. 4 shows pressure being applied to a seal.

FIG. 4A shows how the seal reacts to a small pressure application from the oil.

FIG. 4B demonstrates a seal extruded into the enlarged gap with a small increase in pressure.

FIG. 5-5B demonstrates the same action as FIG. 4-FIG. 4B but the pressure is applied from the opposite direction on the seal.

FIGS. 6-6A show the “nibbling” of the extruded portions of the seal. Repeated applications of pressure will cause the “nibbling” to increase until the seal fails.

FIG. 7-7B are examples of prior art back-up rings, also referred to as anti-extrusion rings.

FIG. 8-8C are side elevation views in section of the mechanism of failure with prior art back-up rings when used with deflected rotating shafts.

FIG. 9-9E are side elevation views of the back-up seal ring installed on a shaft that maintains contact with the shaft.

FIG. 10-FIG. 10B are side elevation views in section of a seal with a back-up ring on an opposite side of the seal.

FIG. 11 and FIG. 11A are side elevation views in section that show the back-up ring remaining in contact with the rotating bearing mandrel as wear progresses.

FIGS. 12 and 12A are side elevation views in section of alternative seal configurations.

FIG. 13 shows a front view of a back-up seal ring.

FIG. 13A shows a side elevation view in section of a back-up seal ring.

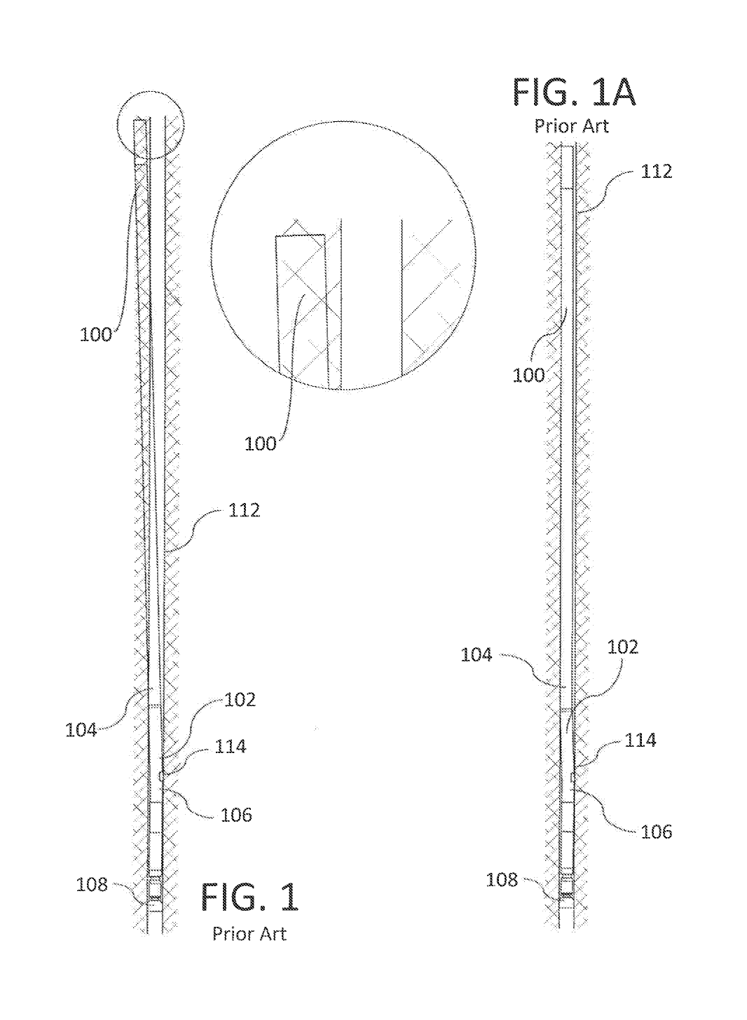

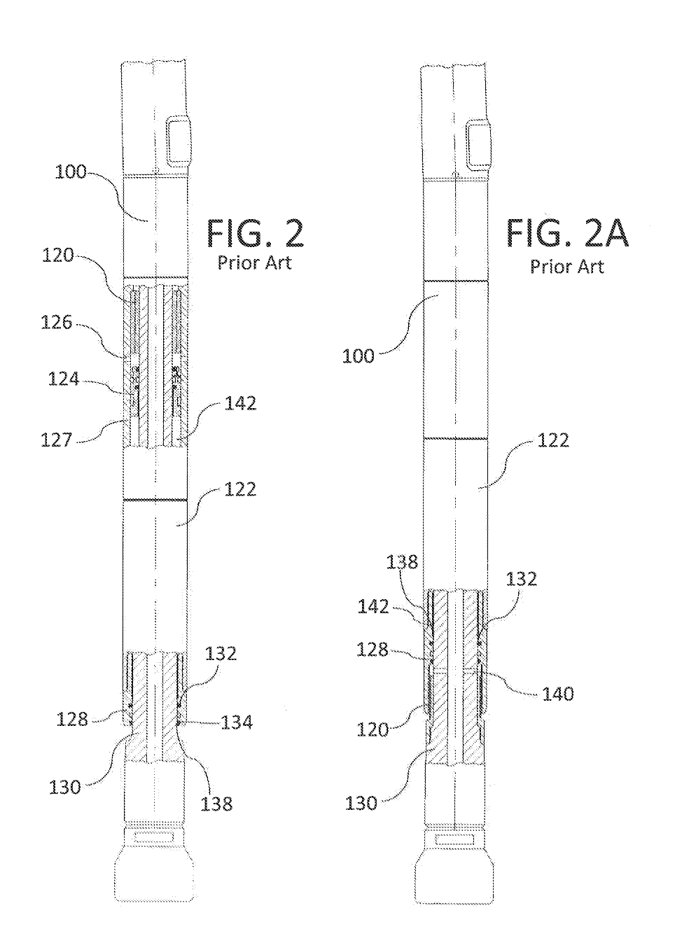

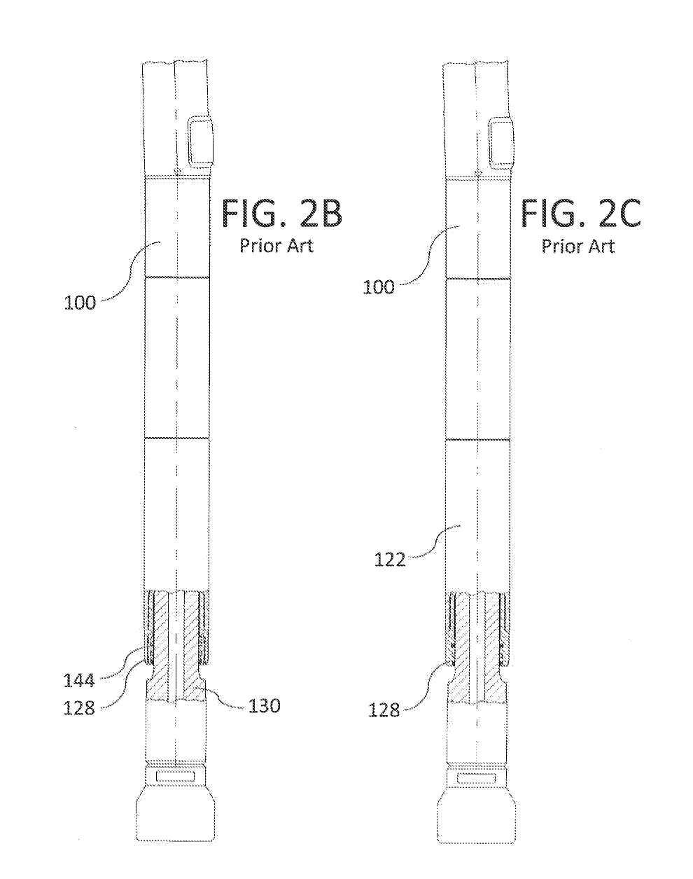

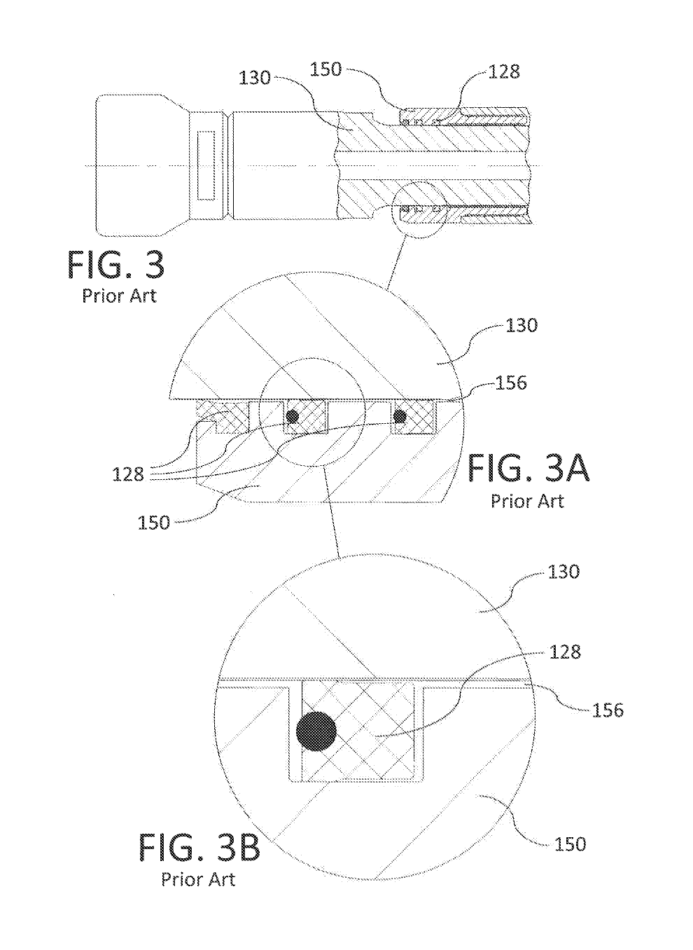

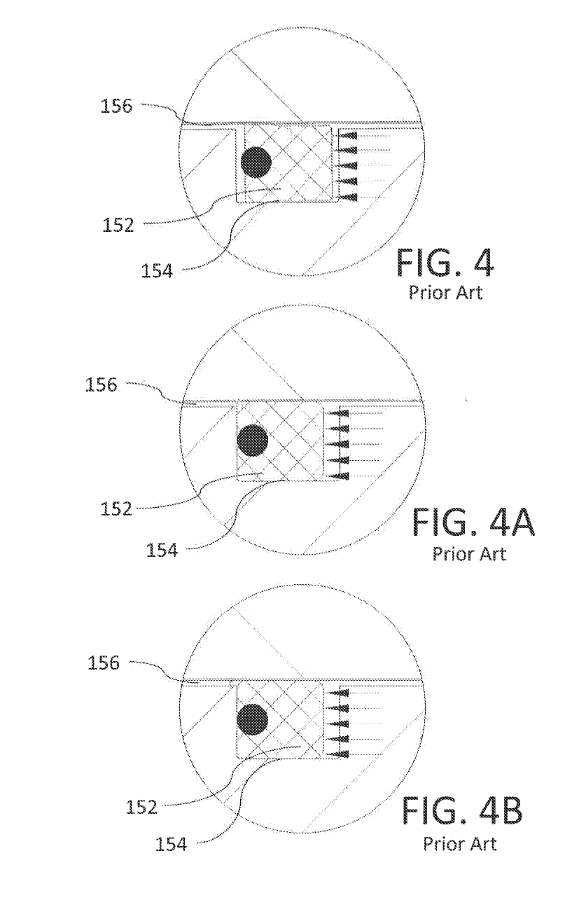

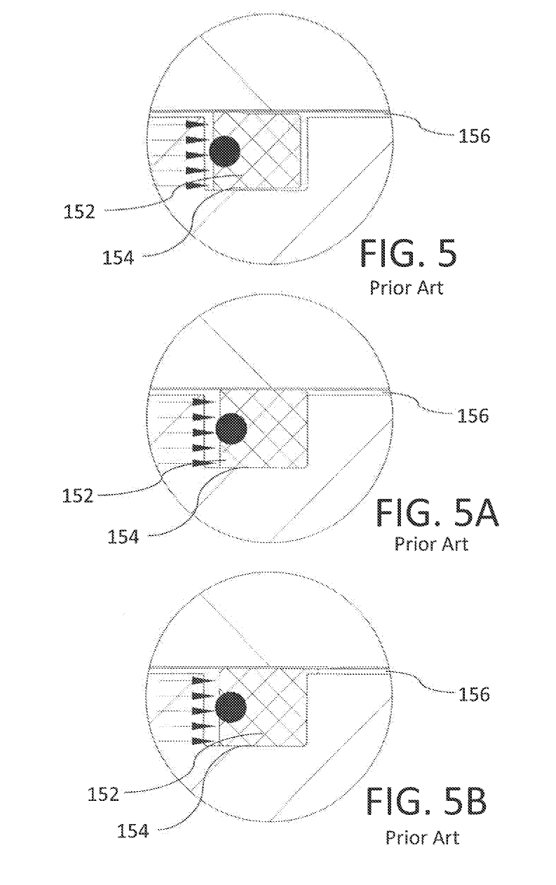

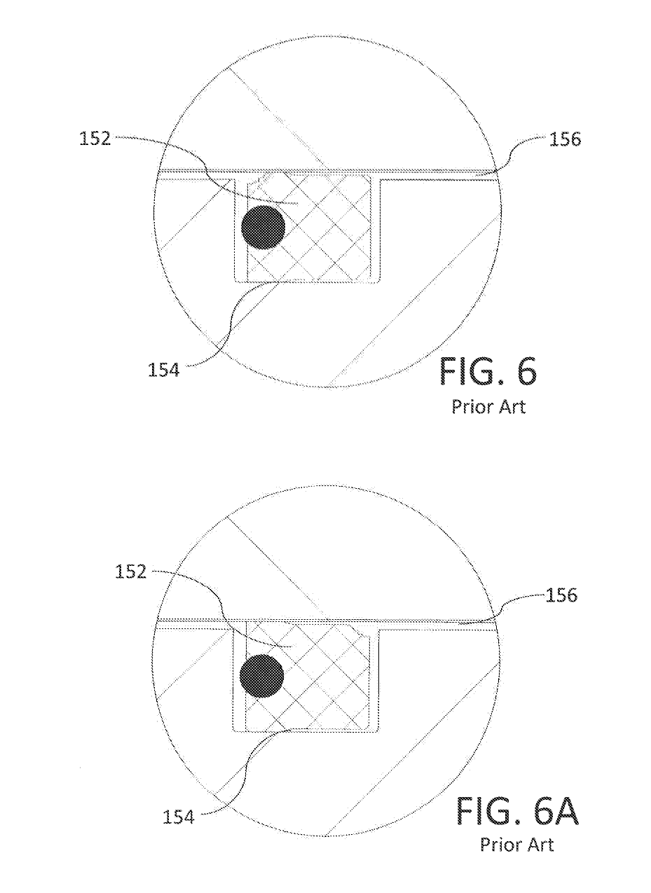

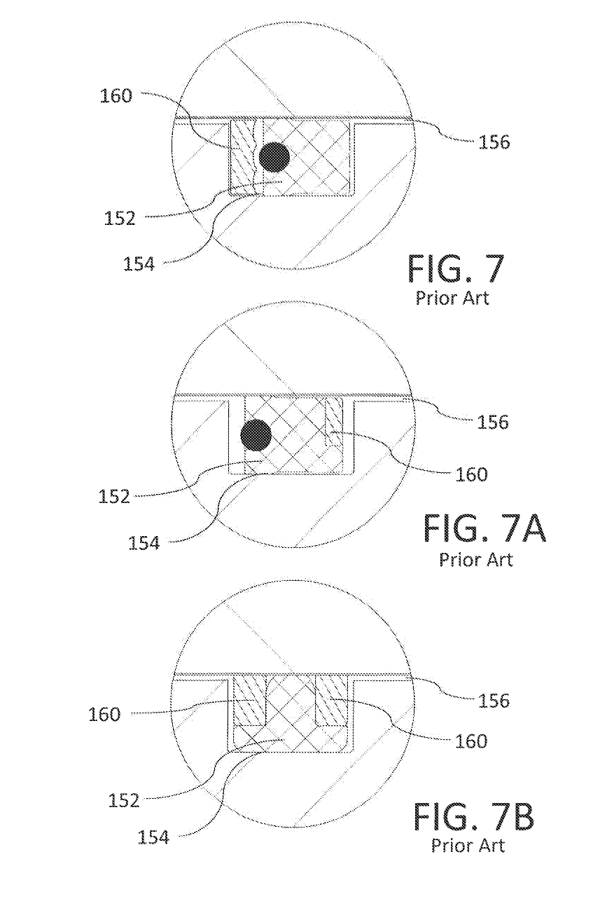

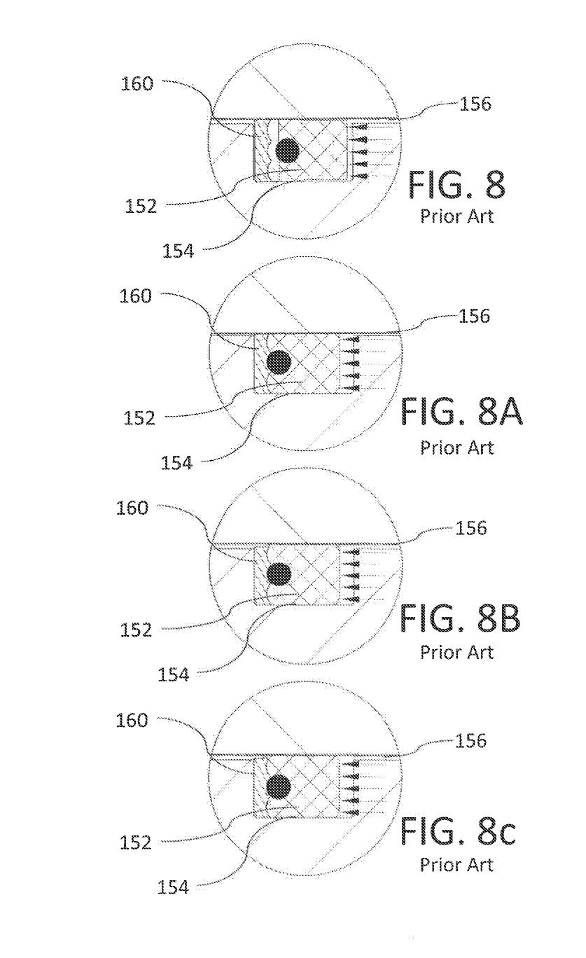

### DETAILED DESCRIPTION

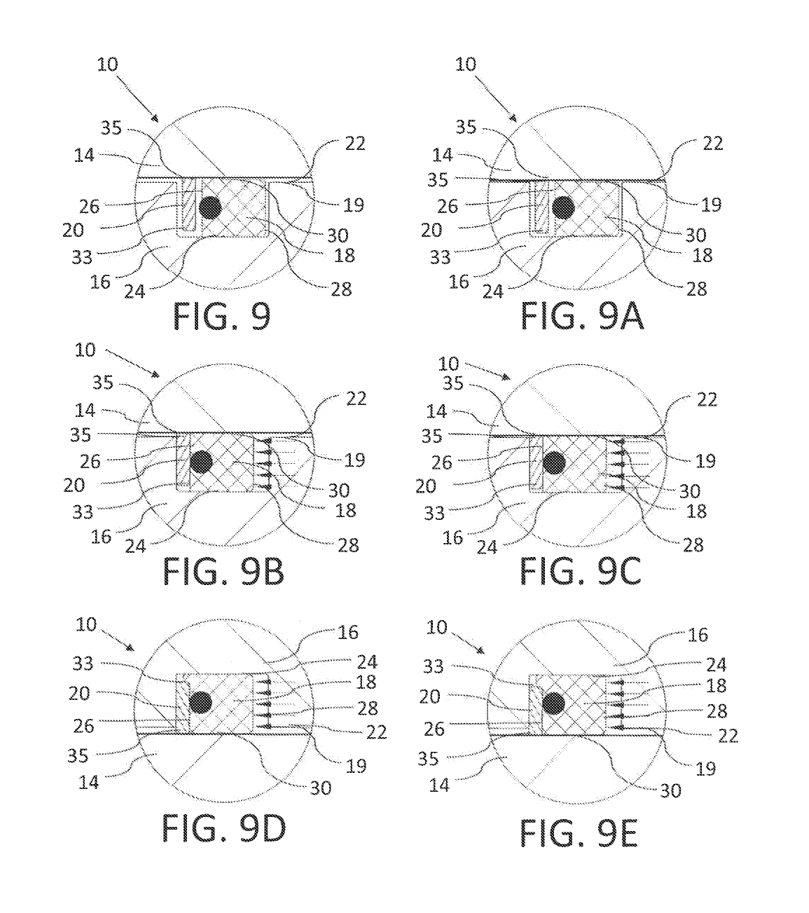

Referring to FIG. 9, there is shown a seal assembly 10 that is able to accommodate moderate pressures with relatively large extrusion gaps between the seal housing 16 and a shaft 14, such as the bearing mandrel in the bearing assembly of a down-hole drilling motor. The design uses an anti-extrusion, or backing, ring 20 in order to reduce deterioration of the seal 18 carried within the seal housing 16 due to extrusion when pressure is applied across the seal 18.

Referring to FIG. 9, the seal housing 16 has an inner surface 19 defining a central bore 22 that is sized to receive the shaft 14 and a seal-receiving groove 24 formed in the inner surface 19. As can be seen, seal-receiving groove 24 is open to the central bore 22 to allow the elastomeric seal 18 to engage and seal against the shaft 14 when positioned within the seal-receiving groove 24 and installed on the shaft 14. The elastomeric seal 18 has a first side surface 26, a second side surface 28, and an inner seal surface 30 that extends between the first and second side surfaces 26 and 28. The anti-extrusion ring 20 is positioned within the seal-receiving groove 24 adjacent to the elastomeric seal 18. As will be discussed below, the backup ring 20 may be positioned on the high pressure side, the low pressure side, or both sides of the seal 18.

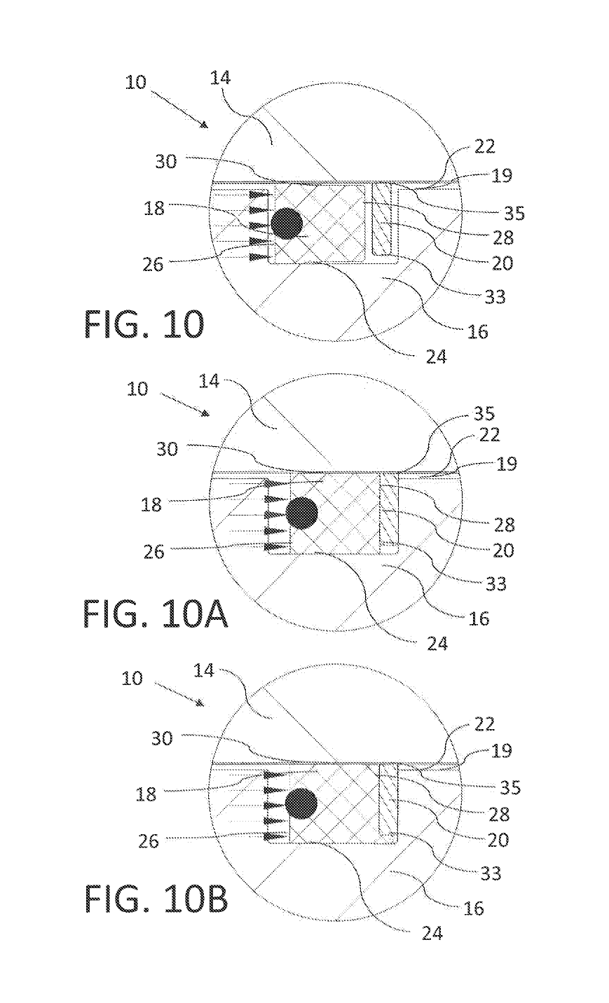

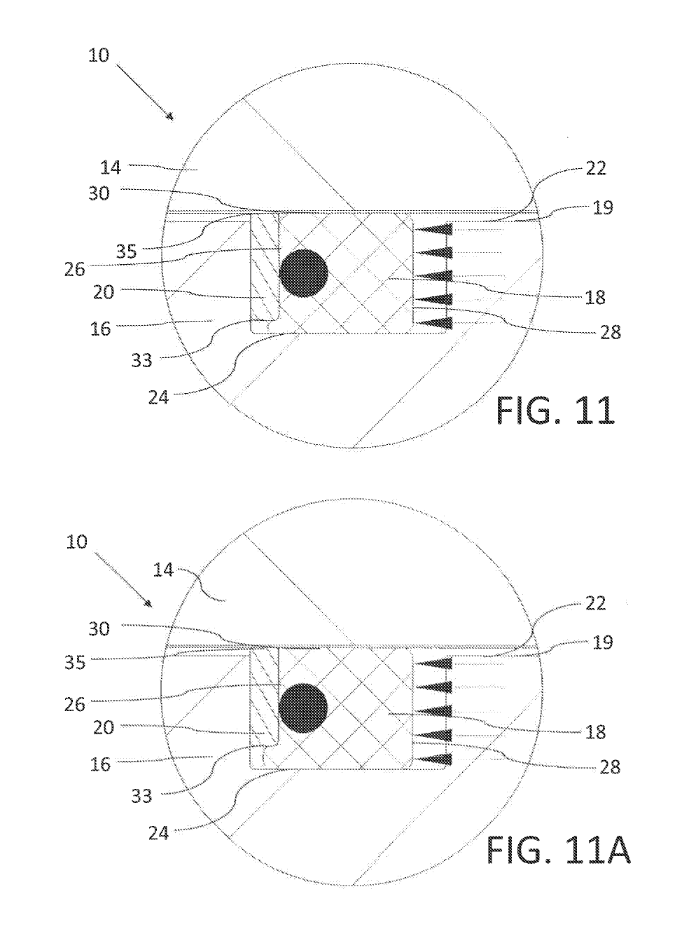

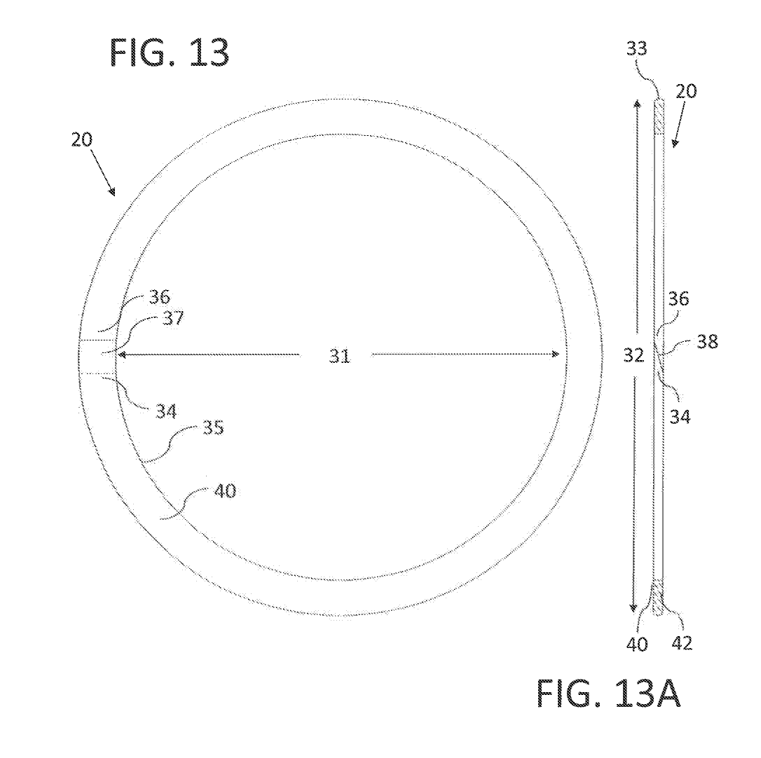

Referring to FIGS. 13 and 13A, the anti-extrusion ring 20 has an inside surface 35 with an inner diameter 31, an outside surface 33 with an outer diameter 32 and is formed from a pliable material. The anti-extrusion ring 20 is a split ring design that has a first end 34 and a second end 36 such that the inner diameter 31 of the anti-extrusion ring 20 conforms to the outer diameter of the mandrel 14 by virtue of its size and in response to pressure applied by the elastomeric seal, as will be described below. As shown, the split ring design of ring 20 is defined by a cut 38, such as an angled cut, that extends between the first and second sides 40 and 42 of anti-extrusion ring 20. By providing the backup ring 20 with first and second ends 34 and 36, the inner diameter 31 of the ring 20 can be adjusted by causing the inner circumference of the ring 20 to conform to the outer diameter of the shaft 14 along its circumference, i.e. by causing the diameter of backup ring 20 to be reduced without compressing the thickness of ring 20. This allows the backup ring 20 to be adjustable while still being made from a material that resists extrusion under the pressures that are likely to be encountered. Pressure is applied to the backup ring 20 to cause it to conform to shall 14 by the elastomeric seal 18. Referring to FIG. 10B, elastomeric seal 18 under pressure will apply a force to the outside surface 33 of the anti-extrusion ring 20 when pressure is applied.

It will be understood that the split in the backup ring 20 may be designed in various ways to permit the first and second ends 34 and 36 to move relative to each other to permit adjustment to the diameter of backup ring 20. While not preferred, this may include a gap between the ends, such that the ring 20 is not closed, or an overlapping split ring such as one would find in a key ring. An angled cut 38 is preferred as shown as it is relatively easy to manufacture, provides a closed structure at different diameters, and provides a ramp surface that allows relative movement of the ends 34 and 36 when changing the diameter of the backup ring 20. As such, first and second ends 34 and 36 form an overlapping section that allow the diameter of ring 20 to be adjusted.

In the example shown in FIG. 9-9E, the ring 20 is placed on the low-pressure side of each axially constrained seal 18. Anti-extrusion ring 20 prevents extrusion damage to the elastomer seal 18 when pressure is applied. The anti-extrusion ring 20 is arranged in a manner to accommodate the shaft 14, or bearing mandrel, deflection and adjust to wear from the abrasive drilling fluids. The ability of the anti-extrusion ring 20 to maintain contact with the shaft 14 ensures the seal 18 cannot protrude into the enlarged gap between the seal housing 16 that axially contains the seals 18 and bearing mandrel 14. FIG. 9 represents the installed seal 18 and back-up ring 20. The back-up ring 20 fits closely to the shaft 14 with clearance between the outside surface 33 of the back-up ring 20 and the seal groove 24. This clearance is equal to, or slightly larger than the gap between the bearing mandrel 14 and the seal housing 16. When the bearing mandrel 14 deflects, the back-up ring 20 moves with the deflection by using the clearance about its outside surface 33 as in FIG. 9A. In FIG. 9B and FIG. 9C, the same mechanism occurs when pressure is applied across the seal 18. FIG. 9D and FIG. 9E shows how the opposite side of the back-up ring reacts to deflection. The gap and clearance grow larger, and applied pressure help the back-up ring 20 stay in contact with the rotating bearing mandrel 14 by partial extrusion of the elastomer 18 over the outside surface 33 of the back-up ring 20. The extrusion in this case is static and there is no resulting damage to the seal 18.

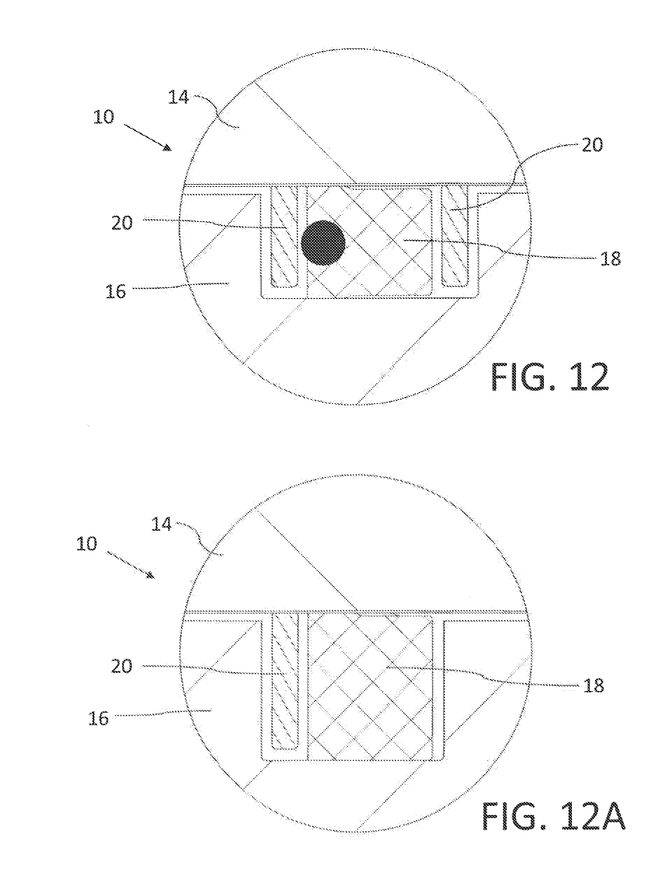

Referring to FIG. 10, it will be understood that the same approach can he used on the opposite side of the seal 18 as well. FIG. 11-FIG. 11A depict how, even with the progression of wear of the back-up ring 20, it is able to stay in contact with the rotating bearing mandrel 14 as wear progresses. The elastomer 18 continues to form around the outside surface 33, applying pressure to the back-up ring 20 and keeping it in contact with the rotating bearing mandrel 14. This action ensures elimination of an extrusion gap on the rotating shaft 14 and preserves the elastomer seal 18 for extended life and higher pressures. Referring to FIG. 12, it will be understood that the same approach may also be used on both sides of the seat 18. Referring to FIG. 12A, it will also be understood that hack-up ring 20 may he used with different configurations and forms of seal 18.

The inside surface 35 of anti-extrusion ring 20 is designed to fit tight to the shaft 14 with a large clearance provided about the outside surface 33 in the axially constrained seal housing 16. The clearance on the outside surface 33 is greater than the expected deflection, or gap between the shaft 14 and seal housing 16. Additionally, referring to 13 and 13A, the anti-extrusion ring 20 is diagonally split or cut in one spot to form an overlap in the axial direction and ensure the seal 16 is always protected from extrusion. The diagonal cut in the back-up ring also allows it to remain in contact with the rotating shaft 14 with little applied pressure from the outside surface 33. The material of the ring should be a material that is pliable or that is sufficiently soft to conform to the shaft 14 at the anticipated operating temperatures and pressures, while resisting extrusion. One suitable material may be PEEK (polyetheretherketone). The outer surface 33 of the ring 20 preferably has a larger radius to allow the elastomer to form around it while the inner surface 35 is flat and has a sharper edge to prevent extrusion of the elastomer under pressure.

An elastomer seal 18, when subjected to a significant pressure differential, fills the space available on the low-pressure side of the axially constrained groove 24. With the anti-extrusion ring 20 on the low-pressure side of the seal 18, the seal 18 takes the shape of the space available. The space between the outside diameter of the anti-extrusion ring 20 and the groove 24 is filled with the elastomer seal 18 and tends to squeeze the anti-extrusion ring 20 onto the shaft 14. This action ensures the inside surface 35 of the anti-extrusion ring 20 stays in contact with, or in close proximity to, the shaft 14 to minimize or eliminate the extrusion gap at the shaft surface.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

1. A seal assembly for sealing against an outer surface of a rotating shaft having an outer diameter, the seal assembly comprising:
a seal housing having an inner surface defining a central bore that is sized to receive the shaft, the shaft and the central bore being separated by a deflection gap that, ire use permits the shaft to deflect within the central bore, the seal housing having at least one seal-receiving groove formed in the inner surface and that is open to the central bore, the at least one seal-receiving groove having a rear wall spaced from and parallel to the central bore;
an elastomeric seal positioned within the seal-receiving groove, the elastomeric seal having a first side surface and a second side surface, and an inner seal surface that extends between the first and second side surfaces, the inner seal surface sealingly engaging the rotating shaft in operation; and
an anti-extrusion ring positioned within the seal-receiving groove and adjacent to the first side surface of the elastomeric seal, the anti-extrusion ring having an inner diameter adjacent to the shaft and an outer diameter spaced from the rear wall of the seal-receiving groove toward the central bore a distance that is greater than the deflection gap, the anti-extrusion ring being formed from a pliable material and being a split ring having a first end and a second end such that the inner diameter of the anti-extrusion ring conforms to the outer diameter of the shaft in response to pressure applied by the elastomeric seal.

2. The seal assembly of claim 1, wherein the first and second ends of the split ring are defined by a cut that extends from a first side of the ring to a second side of the ring.

3. The seal assembly of claim 1, wherein the first and second ends of the split ring are defined by an angled cut, the angled cut acting as a ramp to permit the anti-extrusion ring to expand and contract as the first end moves relative to the second end along the angled cut.

4. The seal assembly of claim 1, wherein an outer surface of the anti-extrusion ring comprises a curved surface such that the elastomer forms around the curved surface under pressure.

5. The seal assembly of claim 1, wherein an inner surface of the anti-extrusion ring is flat such that, as the inner surface engages the shaft, extrusion of the elastomeric seal between the shaft and the anti-extrusion ring under pressure is prevented.

6. The seal assembly of claim 1, wherein the first side-of seal assembly is the high pressure side of the seal assembly.

7. The seal assembly of claim 1, wherein the first side of the seal assembly is the low pressure side of the seal assembly.

8. The seal assembly of claim 1, further comprising a second anti-extrusion ring adjacent to the second side of the elastomeric seal.

9. The seal assembly of claim 1, wherein, in response to fluid pressure in the seal housing, the elastomeric seal extrudes around the outer diameter of the anti-extrusion ring and applies pressure directly to the outer diameter of the anti-extrusion ring.
